(19) United States
(12) Patent Application Publication
(10) Pub. No.: US 2009/0167083 A1
(43) Pub. Date: Jul. 2, 2009

(54) Apparatus and methods for providing multiple output voltages

(75) Inventors: Chuan-Chiung Kuo, Taipei (TW); Shih-Chen Hung, Taoyuan (TW)

Correspondence Address: PATENT PROSECUTION;O2MIRCO , INC., 3118 PATRICK HENRY DRIVE, SANTA CLARA, CA, 95054, US

(73) Assignee: O2Micro, Inc.

(21) Appl. No.: 12/005,484

(22) Filed: Dec. 27, 2007

(51) Int. Cl. H02J 1/00

(52) U.S. Cl. 307/31

(57) ABSTRACT

In one embodiment, an electrical connector apparatus providing multiple output voltages comprises an input terminal, a DC to DC converter, and a plurality of output terminals. The input terminal receives a DC input voltage. The DC to DC converter converts the DC input voltage to at least one DC output voltage. The output terminals provide the DC output voltage to a number of loads simultaneously. The output terminals have a number of terminal structures configured to be matched to a number of structure requirements of the loads respectively.

### TECHNICAL FIELD

The present invention relates to electrical apparatuses, and more particularly, to electrical connectors.

### BACKGROUND

Today, different kinds of portable electronic apparatuses (e.g. laptop computer, cell phone, digital still camera (DSC), digital video camera (DVC), personal digital assistant (PDA), etc.) have become indispensable in people's life. Although these portable electronic apparatuses can use dry cell batteries (e.g., AAA alkaline batteries) as a power source, some portable electronic apparatuses tend to use a rechargeable battery. The energy used to recharge the rechargeable battery can come from mains electricity supply using an alternating current (AC) to direct current (DC) converter. The AC to DC converter transfers an AC voltage (e.g., AC voltage of 110V) of the mains electricity supply to a DC voltage (e.g. DC voltage of 5.5V) to power a particular portable electronic apparatus.

However, different portable electronic apparatuses may require different AC to DC converters to charge their rechargeable batteries. As such, to solve the power shortage problem of portable electronic apparatuses, travelers may have to bring various AC to DC converters respectively for the portable electronic apparatuses with them. The AC to DC converters may not only occupy extra room of the luggage but also increase the luggage weight. Furthermore, the AC to DC converter is plugged into a socket to receive the AC voltage from the mains electricity supply. If the socket number is limited, the portable electronic apparatuses may have to be charged one by one, which can be time-consuming.

### SUMMARY

Embodiments in accordance with the present invention provide apparatuses and methods for providing multiple output voltages. In one embodiment, an electrical connector apparatus providing multiple output voltages comprises an input terminal, a DC to DC converter, and a plurality of output terminals. The input terminal receives a DC input voltage. The DC to DC converter converts the DC input voltage to at least one DC output voltage. The output terminals provide the DC output voltage to a number of loads simultaneously. The output terminals have a number of terminal structures configured to be matched to a number of structure requirements of the loads respectively.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a schematic diagram of an electrical connector apparatus, in accordance with one embodiment of the present invention.

FIG. 2 is a schematic diagram of an electrical connector apparatus, in accordance with another embodiment of the present invention.

FIG. 3 is a schematic diagram of a system for providing multiple output voltages, in accordance with one embodiment of the present invention.

FIG. 4 is a schematic diagram of a system for providing multiple output voltages, in accordance with another embodiment of the present invention.

FIG. 5 is a flowchart of a method of providing voltages to a number of loads, in accordance with one embodiment of the present invention.

### DETAILED DESCRIPTION

Reference will now be made in detail to embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

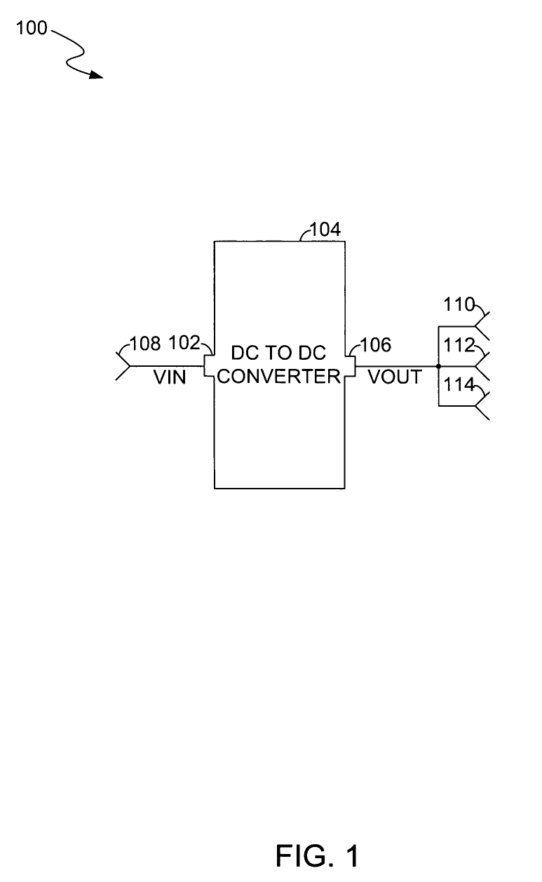

FIG. 1 illustrates an electrical connector apparatus 100, in accordance with one embodiment of the present invention. The electrical connector apparatus 100 includes an input terminal 108, a DC to DC converter 104, and a number of output terminals, e.g., shown as the output terminals 110, 112, and 114, in one embodiment. However, in one embodiment, any number of output terminals can be included. The electrical connector apparatus 100 receives a DC input voltage VIN from a DC voltage source (not shown in FIG. 1 for purposes of brevity and clarity), e.g., an AC to DC converter, via the input terminal 108, and provides a DC output voltage VOUT to multiple loads (not shown in FIG. 1 for purposes of brevity and clarity), e.g., a cell phone, a digital still camera, a digital video camera, a personal digital assistant, and a laptop computer, etc., via the output terminals 110, 112, and 114, in one embodiment.

The input terminal 108 is coupled to an input pin 102 of the DC to DC converter 104 for providing the DC input voltage VIN. In one embodiment, a voltage level of the DC input voltage VIN is in the range of 3V to 24V. The DC input voltage VIN is converted to a DC output voltage VOUT of a particular voltage level by the DC to DC converter 104. In one embodiment, the particular voltage level of the DC output voltage VOUT can be 5.5V. In practice, the DC to DC converter 104 can be O2 Micro's OZ818 chip (by way of example), which is capable of converting an input voltage in the range of 9V to 24V to an output voltage of 5.5V.

The output terminals 110, 112, and 114 are coupled to an output pin 106 of the DC to DC converter 104 for transferring the DC output voltage VOUT to multiple loads simultaneously. Advantageously, even if the socket number is limited, multiple loads attached to the output terminals 110, 112, and 114 can still be powered/charged simultaneously via the electrical connector apparatus 100 by a single DC voltage source (e.g., an AC to DC converter), rather than being powered/charged one by one in a conventional way.

Furthermore, multiple loads may have various structure requirements for terminals attached to them. In this instance, the output terminals 110, 112, and 114 can be specially constructed to mechanically match the various structure requirements of multiple loads. In other words, the output terminals 110, 112, and 114 can have structures to mechanically match the structure requirements of multiple loads, respectively. For example, multiple loads comprise a first portable electronic apparatus, a second portable electronic apparatus, and a third portable electronic apparatus. The first portable electronic apparatus can be attached to an output terminal with a universal serial bus (USB) plug, while the second and third portable electronic apparatuses can be attached to the output terminals with a mini USB plug and an IEEE 1394 cable plug, respectively. In this instance, the output terminals 110, 112 and 114 can be constructed to be a USB port, a mini USB port and an IEEE 1394 cable port, respectively, so as to mechanically match the structure requirements of the first, second and third portable electronic apparatuses.

As such, the electrical connector apparatus 100 can mechanically match the structure requirements of multiple loads (e.g., a cell phone, a digital still camera, and a laptop computer) so as to power/charge multiple loads by a single DC voltage source (e.g., an AC to DC converter). Advantageously, travelers can now bring one voltage source (e.g., an AC to DC converter) with the electrical connector apparatus 100 to power/charge multiple portable electronic apparatuses simultaneously, rather than bringing different AC to DC converters. Furthermore, since the electrical connector apparatus 100 has a relatively small size, the luggage room can be saved and the luggage weight can be reduced. For example, the length and width of the electrical connector apparatus 100 (e.g., O2 Micro Cool Traveler) can be 59 mm and 35 mm respectively.

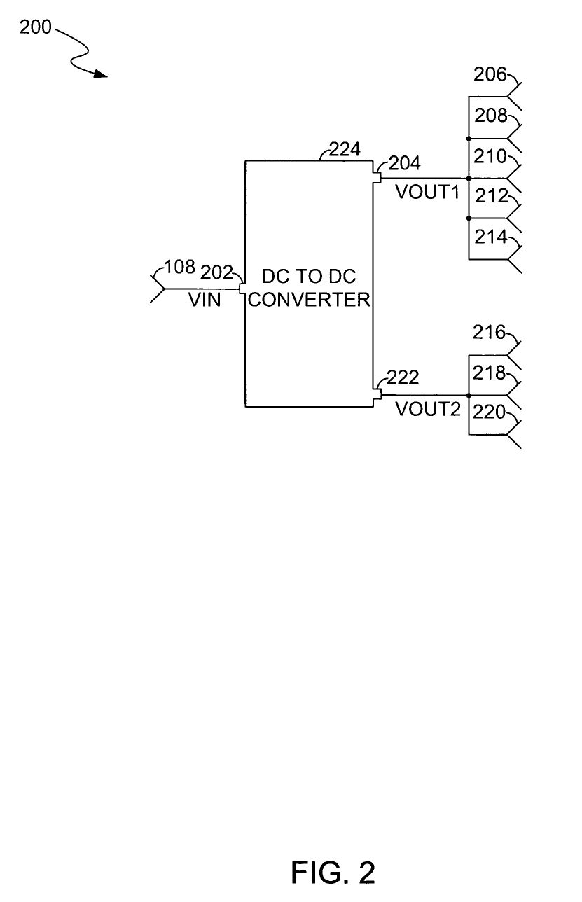

FIG. 2 illustrates an electrical connector apparatus 200, in accordance with another embodiment of the present invention. Elements labeled the same in FIG. 1 have similar functions and will not be repetitively described herein for purposes of brevity and clarity. The electrical connector apparatus 200 includes the input terminal 108, a DC to DC converter 224, and a number of output terminals, e.g., shown as the output terminals 206, 208, 210, 212, 214, 216, 218, and 220, in one embodiment. However, in one embodiment, any number of output terminals can be included. Similarly, the electrical connector apparatus 200 receives a DC input voltage VIN from a single DC voltage source (not shown in FIG. 2 for purposes of brevity and clarity) via the input terminal 108. Furthermore, the electrical connector apparatus 200 provides a number of DC output voltages, e.g., shown as a DC output voltage VOUT1 and a DC output voltage VOUT2, to multiple loads (not shown in FIG. 2 for purposes of brevity and clarity) via the output terminals 206, 208, 210, 212, 214, 216, 218, and 220, in one embodiment.

The input terminal 108 is coupled to an input pin 202 of the DC to DC converter 224. The DC to DC converter 224 converts the DC input voltage VIN to a number of DC output voltages with different voltage levels. For example, the DC output voltage VOUT1 can have a first voltage level of 5.5V, and the DC output voltage VOUT2 can have a second voltage level of 10V. In practice, the DC to DC converter 224 can be O2 Micro's Robin Hood II chip (by way of example), which is capable of converting an input voltage in the range of 9V to 24V to an output voltage of 5.5V and an output voltage of 10V.

The output terminals 206, 208, 210, 212, 214, 216, 218, and 220 are coupled to a number of output pins, e.g., shown as an output pin 204 and an output pin 222, of the DC to DC converter 224 for transferring the DC output voltage VOUT1 and the DC output voltage VOUT2 to multiple loads. When the output terminals 206, 208, 210, 212, 214, 216, 218, and 220 attach to multiple loads, these loads can be respectively powered/charged by the DC output voltages simultaneously. Similarly, the output terminals 206, 208, 210, 212, 214, 216, 218, and 220 can be specially constructed to mechanically match the various structure requirements of multiple loads. As such, even if multiple loads may require different DC voltages and different terminal structures, the electrical connector apparatus 200 can still power/charge multiple loads simultaneously by providing different DC voltages and different terminals using a single DC voltage source.

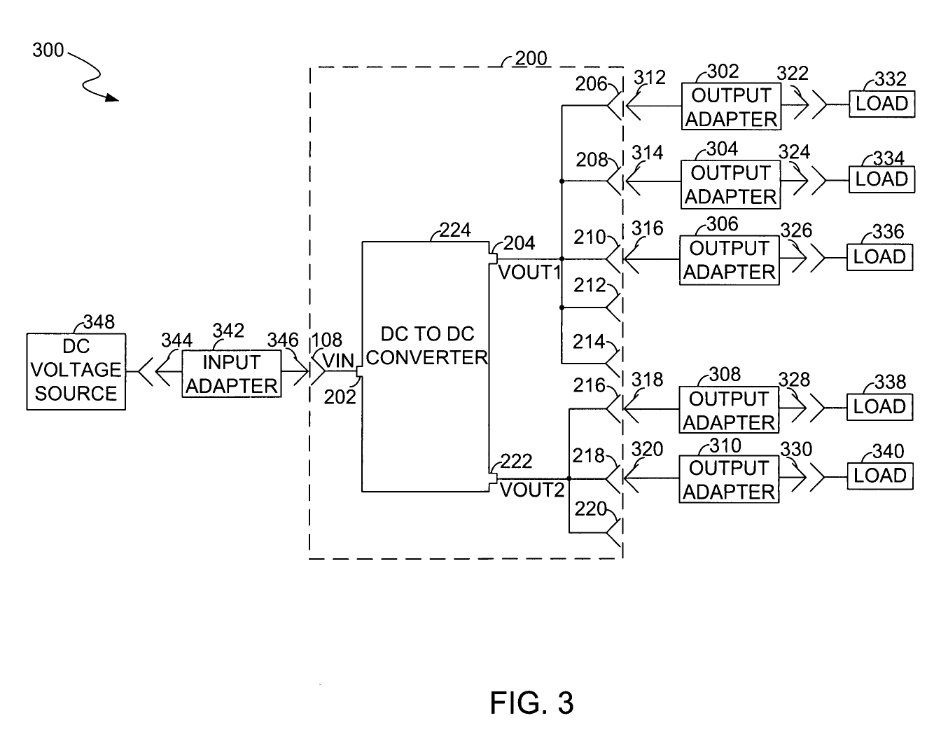

FIG. 3 illustrates a system 300 for providing multiple output voltages, in accordance with one embodiment of the present invention. Elements labeled the same in FIG. 1 and FIG. 2 have similar functions and will not be repetitively described herein for purposes of brevity and clarity. The system 300 includes the electrical connector apparatus 200, a number of output transformation devices, e.g., shown as output adapters 302, 304, 306, 308, and 310, an input transformation device, e.g., shown as an input adapter 342, a DC voltage source 348, and a number of loads 332, 334, 336, 338, and 340, in one embodiment. The output transformation devices and the input transformation device can transfer a voltage from one electronic device to at least one other electronic device. For example, the output transformation devices and the input transformation device can be USB cables. The USB cable can send a voltage from a first terminal to a second terminal. The first terminal can be connected to a power source and the second terminal can be connected to an electronic device being powered/charged. In one embodiment, the output transformation devices shown as the output adapters 302, 304, 306, 308, and 310 further include a number of first terminals, e.g., shown as adapter terminals 312, 314, 316, 318, and 320, and a number of second terminals, e.g., shown as adapter terminals 322, 324, 326, 328, and 330, in one embodiment. Similarly, the input transformation device shown as the input adapter 342, further includes a first terminal, e.g., shown as an adapter terminal 346, and a second terminal, e.g., shown as an adapter terminal 344, in one embodiment. In one embodiment, the DC voltage source 348 can be an AC to DC converter, which converts an AC voltage (e.g., 110V AC voltage) to a DC input voltage VIN (e.g., 9V to 24V DC voltage). In one embodiment, the DC voltage source 348 can also be a power adapter of a laptop computer. The power adapter is a power supply for the laptop computer which converts an AC voltage to a DC voltage required by the laptop computer. The DC voltage source 348 can also be a vehicle cigarette lighter socket which is used to provide a DC voltage to a vehicle cigarette lighter. Using the vehicle cigarette lighter socket as the DC voltage source 348 can make it more convenient to use the electrical connector apparatus 200 in a vehicle.

The electrical connector apparatus 200 receives the DC input voltage VIN from the DC voltage source 348 via the input terminal 108. In one embodiment, the input adapter 342 is coupled between the DC voltage source 348 and the input terminal 108 for transferring the DC input voltage from the DC voltage source 348 to the electrical connector apparatus 200. The adapter terminal 344 of the input adapter 342 is coupled to the DC voltage source 348, and the adapter terminal 346 of the input adapter 342 is coupled to the input terminal 108. Advantageously, the adapter terminals 344 and 346 have structures mechanically matched to an output terminal of the DC voltage source 348 and the input terminal 108, respectively.

As discussed above, the output terminals 206, 208, 210, 212, 214, 216, 218, and 220 can be specially constructed to mechanically match the various structure requirements of loads 332, 334, 336, 338, and 340 respectively. In one embodiment, the various structure requirements of loads 332, 334, 336, 338, and 340 can be respectively determined by the output transformation devices attached to these loads. For example, the output adapter 302 is coupled to the output terminal 206 at the adapter terminal 312 and coupled to the load 332 at the adapter terminal 322 so as to transfer a first DC output voltage VOUT1 (e.g., 5.5V DC voltage) from the electrical connector apparatus 200 to the load 332. As such, the output terminal 206 has a structure mechanically matched to the adapter terminal 312. Also, the adapter terminal 322 is mechanically matched to an input terminal of the load 332. Similarly, the output adapter 304 and the output adapter 306 provide the first DC output voltage VOUT1 to the load 334 and the load 336 respectively. The output adapter 308 and the output adapter 310 provide a second DC output voltage VOUT2 (e.g., 10V DC voltage) from the electrical connector apparatus 200 to the load 338 and the load 340 respectively.

Furthermore, loads 332, 334, 336, 338, and 340 can be portable electronic apparatuses of different manufacturers, functions, and types. In one embodiment, the load 332 can be a cell phone manufactured by N Company, the load 334 can be a digital still camera (DSC) manufactured by P Company, the load 336 can be a digital personal assistant (PDA) manufactured by H Company, the load 338 can be a cell phone manufactured by M Company, and the load 340 can be a digital video camera (DVC) manufactured by S Company (company names shown here are just for illustration purposes). Since the electrical connector apparatus 200 provides a number of DC output voltages of different voltage levels via different output terminals, the portable electronic apparatuses can be powered/charged simultaneously by a single DC voltage source 348.

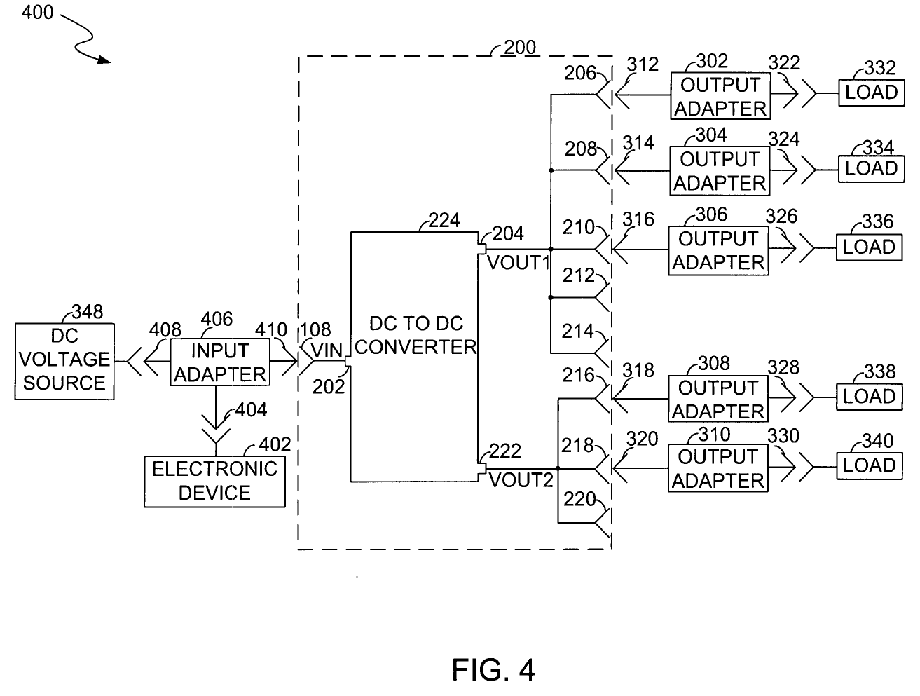

FIG. 4 illustrates a system 400 for providing multiple output voltages, in accordance with another embodiment of the present invention. Elements labeled the same in FIG. 1, FIG. 2, and FIG. 3 have similar functions and will not be repetitively described herein for purposes of brevity and clarity. In system 400, an electronic device (e.g., laptop computer) 402 and the electrical connector apparatus 200 are both connected to the DC voltage source 348 by an input transformation device, e.g., shown as an input adapter 406, in one embodiment. The input transformation device shown as the input adapter 406 has three terminals, e.g., shown as adapter terminals 404, 408, and 410, in one embodiment. The input adapter 406 connects the DC voltage source 348 with the electrical connector apparatus 200 via adapter terminals 408 and 410. Furthermore, the input adapter 406 connects the DC voltage source 348 with the electronic device 402 via adapter terminals 408 and 404. The DC voltage source 348 can provide a DC input voltage to the laptop computer 402 and the electrical connector apparatus 200 simultaneously through the adapter 406. In other words, the electrical connector apparatus 200 can share the DC voltage source 348 with the electronic device 402.

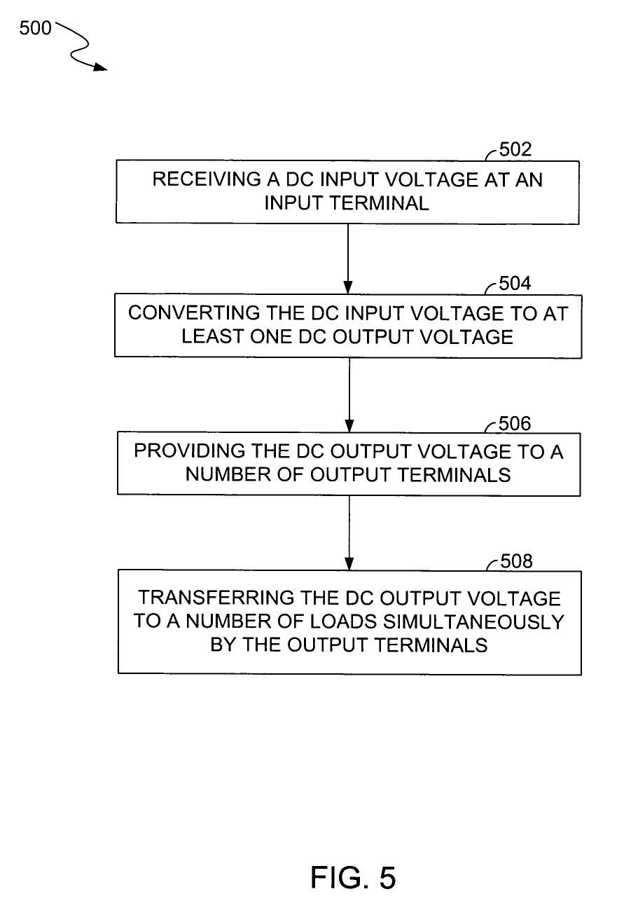

FIG. 5 illustrates a flowchart 500 of a method of providing voltages to a number of loads, in accordance with one embodiment of the present invention. Although specific steps are disclosed in FIG. 5, such steps are exemplary. That is, the present invention is well suited to performing various other steps or variations of the steps recited in FIG. 5. FIG. 5 is described in combination with FIG. 4.

In block 502, a DC input voltage is received at an input terminal. In one embodiment, the input terminal 108 of an electrical connector apparatus 200 receives the DC input voltage provided by a DC voltage source 348.

In block 504, the DC input voltage is converted to at least one DC output voltage. In one embodiment, the DC input voltage VIN is converted to a first DC output voltage VOUT1 and a second DC output voltage VOUT2 by a DC to DC converter 224.

In block 506, the DC output voltage is provided to one or more output terminals. In one embodiment, the DC output voltage VOUT1 is transferred from a first output pin 204 of the DC to DC converter 224 to output terminals 206, 208, 210, 212, and 214. The DC output voltage VOUT2 is transferred from a second output pin 222 of the DC to DC converter 224 to output terminals 216, 218, and 220, in one embodiment.

In block 508, the at least one DC output voltage is transferred to a number of loads via the output terminals simultaneously. In one embodiment, the DC output voltages are transferred to the loads 332, 334, 336, 338, and 340 via output terminals 206, 208, 210, 216, and 218. Furthermore, the output terminals 206, 208, 210, 216, and 218 can have various structures configured to be matched to a number of structure requirements of the loads 332, 334, 336, 338, and 340 respectively.

Furthermore, the DC input voltage from the DC voltage source 348 can be provided to an input transformation device. In one embodiment, the DC input voltage from the DC voltage source 348 is transferred to the input terminal 108 of the electrical connector apparatus via the input transformation device 406. Moreover, the input voltage from the DC voltage source 348 can be transferred to an electronic device so as to enable the electronic device to share the DC input voltage with the input terminal 108 of the electrical connector apparatus. In one embodiment, the input transformation device 406 transfers the DC input voltage from the DC voltage source 348 to the electronic device 402 and the input terminal 108 of the electrical connector apparatus simultaneously. As such, the electronic device 402 and the electrical connector apparatus 200 can share the DC voltage source 348.

To summarize, the electrical connector apparatus provides multiple output voltages from one DC input voltage, in one embodiment. The multiple output terminals of the electrical connector apparatus are capable of providing DC output voltages of different voltage levels and being mechanically matched to different adapter terminals of different loads. As such, the electrical connector apparatus is capable of powering/charging a number of portable electronic apparatuses of different manufacturers, functions, and types by a single DC voltage source simultaneously. Furthermore, the electrical connector apparatus can also be adapt to different DC voltage sources, which makes the electrical connector convenient to use in different situations.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. An electrical connector apparatus comprising:
an input terminal for receiving a DC input voltage;
a DC to DC converter for converting said DC input voltage to at least one DC output voltage; and
a plurality of output terminals for providing said DC output voltage to a plurality of loads simultaneously and having a plurality of terminal structures configured to be matched to a plurality of structure requirements of said plurality of loads respectively.

2. The electrical connector apparatus of claim 1, further comprising:
a plurality of output transformation devices respectively coupled between said plurality of output terminals and said plurality of loads.

3. The electrical connector apparatus of claim 2, wherein said plurality of terminal structures each is mechanically matched to a terminal of one of said plurality of output transformation devices.

4. The electrical connector apparatus of claim 2, wherein a terminal of each of said plurality of output transformation devices is mechanically matched to an input terminal of one of said plurality of loads.

5. The electrical connector apparatus of claim 1, wherein said input terminal is coupled to a single DC voltage source for receiving said DC input voltage.

6. The electrical connector apparatus of claim 5, further comprising:
an input transformation device coupled between said input terminal and said single DC voltage source.

7. The electrical connector apparatus of claim 6, wherein said input terminal is mechanically matched to a terminal of said input transformation device.

8. The electrical connector apparatus of claim 6, wherein a terminal of said input transformation device is mechanically matched to an output of said single DC voltage source.

9. The electrical connector apparatus of claim 6, wherein said input transformation device is operable for transferring said DC input voltage to an electronic device and said input terminal simultaneously.

10. The electrical connector apparatus of claim 9, wherein a terminal of said input transformation device is mechanically matched to an input terminal of said electronic device.

11. The electrical connector apparatus of claim 1, wherein said input terminal is operable for selectively receiving said DC input voltage from at least an AC to DC converter and a vehicle cigarette lighter socket.

12. The electrical connector apparatus of claim 1, wherein said plurality of loads are selected from at least a cell phone, a digital still camera, a digital video camera, and a personal digital assistant.

13. The electrical connector apparatus of claim 1, wherein said DC to DC converter converts said DC input voltage to a plurality of DC output voltages of different voltage levels.

14. A method for providing voltages to a plurality of loads, comprising:
receiving a DC input voltage at an input terminal;
converting said DC input voltage to at least one DC output voltage;
transferring said DC output voltage to said plurality of loads simultaneously by a plurality of output terminals respectively; and
matching a plurality of terminal structures of said plurality of output terminals to a plurality of structure requirements of said plurality of loads respectively.

15. The method of claim 14, further comprising:
transferring said DC input voltage from a DC power source to said input terminal.

16. The method of claim 15, further comprising:
transferring said DC input voltage from said DC power source to an electronic device so as to enable said electronic device to share said DC input voltage with said input terminal.

17. The method of claim 14, further comprising:
transferring said DC output voltage from said plurality of output terminals to said plurality of loads respectively.

18. A system comprising:
a DC voltage source for providing a DC input voltage;
a plurality of loads having a plurality of structure requirements; and
an electrical connector apparatus for converting said DC input voltage to at least one DC output voltage and for providing said at least one DC output voltage to said plurality of loads simultaneously, said electrical connector apparatus comprising a plurality of output terminals coupled to said plurality of loads respectively and having a plurality of terminal structures configured to be matched to a plurality of structure requirements of said plurality of loads respectively.

19. The system of claim 18, further comprising:
an input transformation device for receiving said DC input voltage from said DC voltage source and for transferring said DC input voltage to said electrical connector apparatus.

20. The system of claim 19, wherein said input transformation device is coupled to an electronic device and for transferring said DC input voltage to said electronic device and said electrical connector apparatus simultaneously.

21. The system of claim 18, further comprising:
a plurality of output transformation devices for receiving said at least one DC output voltage and for transferring said at least one DC output voltage to said plurality of loads.

22. The system of claim 18, wherein said DC voltage source is selected from at least an AC to DC converter and a vehicle cigarette lighter socket.

23. The system of claim 18, wherein said plurality of loads are selected from at least a cell phone, a digital still camera, a digital video camera, and a personal digital assistant.
